(19) United States
(12) Patent Application Publication
(10) Pub. No.: US 2007/0014902 A1
(43) Pub. Date: Jan. 18, 2007

(54) Ice cream holder

(76) Inventor: Alan Bogdanovski, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/476,417

(22) Filed: Jun. 27, 2006

Related U.S. Application Data
(60) Provisional application No. 60/695,824, filed on Jun. 30, 2005.

(51) Int. Cl. A23G 3/20

(52) U.S. Cl. 426/282

(57) ABSTRACT

An ice cream holder including: a hand-engaging surface; and an ice cream engaging platform mounted to the hand engaging surface; and a collector disposed between the hand-engaging surface and the ice cream engaging platform adapted for collecting ice-cream that is spilt from the ice-cream engaging surface when in use.

### CROSS REFERENCE TO RELATED APPLICATIONS

This application claims priority under 35 U.S.C. §119(e) to U.S. Provisional Application No. 60/695,824 filed Jun. 30, 2005 incorporated by reference in it's entirety.

### TECHNICAL FIELD

The present invention relates to the field of ice-cream cones.

### BACKGROUND OF THE INVENTION

Ice cream is commonly served in edible waffle cones. Unfortunately, with existing ice cream cones, as the ice cream begins to melt, the ice cream resting in the cone tends to drip over the rim of the cone and on to the user's hand resulting in an overall uncomfortable experience for the user. This problem is particularly evident where small children are involved which may be due to the lack of hand coordination in holding the ice cream cone steady.

### SUMMARY OF THE INVENTION

The present invention seeks to alleviate at least one problem associated with the above-described prior art.

In a first broad form, the present invention provides an ice cream holder including:
a hand-engaging surface; and
an ice cream engaging platform mounted to the hand engaging surface; and
a collector disposed between the hand-engaging surface and the ice cream engaging platform adapted for collecting ice-cream that is spilt from the ice-cream engaging surface when in use.

Typically, the present invention may include an edible material such as a wafer. In certain embodiments, the present invention may be formed from a single wafer, or alternatively, from a plurality of wafers joined together.

Preferably, the hand-engaging surface includes a cone having a recess, a rim, an inner and outer surface, and a tapered end. In use, the tapered end may generally be held in a user's hand such that the circular rim is directed upwardly in use.

Typically, the ice cream engaging platform includes an upper surface upon which ice cream may be deposited in use, a sidewall, and, a base. The upper surface may include a substantially flat surface, or alternatively, may include a recessed surface.

Preferably, the collector includes at least any one of the following:
a trough; or
a guard disposed between, and extending outwardly from, the ice cream engaging platform and the hand engaging surface. For instance, this may include a lip disposed on the rim of the ice cream cone which may be adapted to protectively curve over the user's hand in use.

Preferably, the base of the ice cream engaging platform may be connected to the inner surface of the cone whereby a trough is formed between the sidewall of the ice cream engaging platform and the inner surface of the cone. In certain embodiments, a plurality of apertures may be disposed along a bottom surface of the trough so as to conveniently provide drainage for ice cream that has accumulated within the trough into a hollow tapered section of the cone. Also preferably, the ice cream engaging platform is mounted to the hand engaging surface such that it is arranged in an elevated position relative to the collector when in use.

Typically, the present invention includes a plurality of support frames disposed within the trough in spaced-apart fashion which brace the sidewall of the ice cream engaging platform against the inner surface of the cone.

### BRIEF DESCRIPTION OF THE DRAWINGS

The present invention will become better understood from the following detailed description of a preferred but non-limiting embodiment thereof, described in connection with the accompanying figures, wherein:

FIG. 1 depicts a first embodiment of the present invention.

FIG. 2 depicts the first embodiment of the present invention wherein a top region of the cone is depicted transparently wherein a trough is visible.

FIG. 3 depicts a top view of the first embodiment of the present invention.

FIG. 4 depicts a second embodiment of the present invention where the cone is shown having a flat-bottom.

### BEST MODES FOR CARRYING OUT THE INVENTION

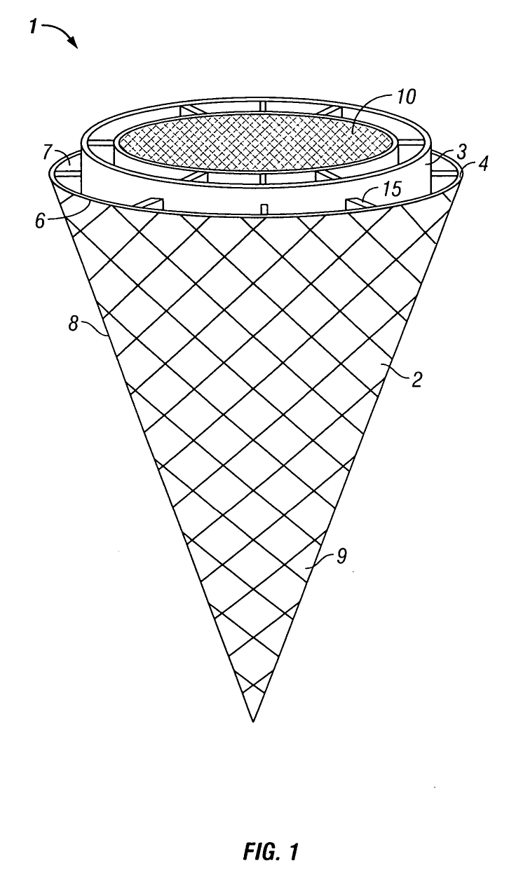

FIGS. 1 to 3 depict a first embodiment (1) of the present invention including an ice cream cone (2), an ice cream engaging platform (3) mounted to the ice cream cone (2) adjacent to a cone opening (4) which is adapted for holding a scoop of ice cream, and a trough (5) disposed between the ice cream cone (2) and the ice cream engaging platform (3), the trough (5) being adapted for collecting ice cream which spills from the ice cream engaging platform (3). FIG. 4 depicts a second embodiment of the present invention wherein the tapered end includes a substantially flat surface adapted for standing the cone upright.

The ice cream cone (2) also includes a rim (6), an inner and outer surface (7,8), and a tapered end (9).

The ice cream cone (2) and the ice-cream engaging surface (3) are made from an edible wafer substance. The first embodiment (1) is made by forming the ice cream engaging platform (3) and the ice cream cone (2) separately and then, bonding them together using a suitably edible adhesive substance. In alternative embodiments of the present invention they may be formed integrally using extrusion moulding techniques.

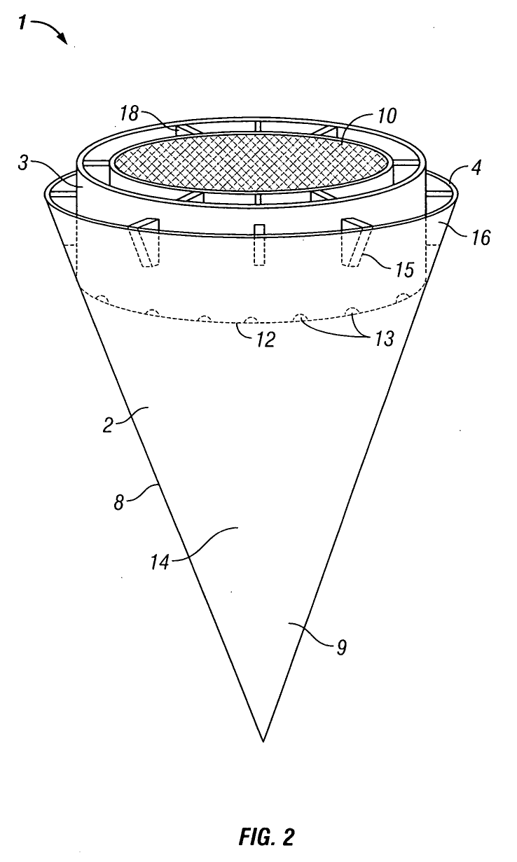

As shown in FIGS. 1 and 2, the ice cream engaging platform (3) includes an upper surface (10) upon which ice cream is deposited in use, a sidewall (11), and, a base (12). The upper surface (10) includes a curved recess.

In this first embodiment, the base (12) of the ice cream engaging platform (3) is attached to the inner surface (7) of the cone (2) whereby the trough (5) is formed between the sidewall (11) of the ice cream engaging platform (3) and the inner surface (7) of the cone (2). Also in the first embodiment, a plurality of apertures (13) are disposed along a bottom surface of the trough (5) which provide drainage for any ice cream that is accumulated within the trough (5) to drain into a hollow tapered section (14) of the cone (2). FIG. 2 shows more clearly in transparent fashion the intersection of the base (12) of the ice cream engaging platform (3) and the inner surface (7) of the cone (2.

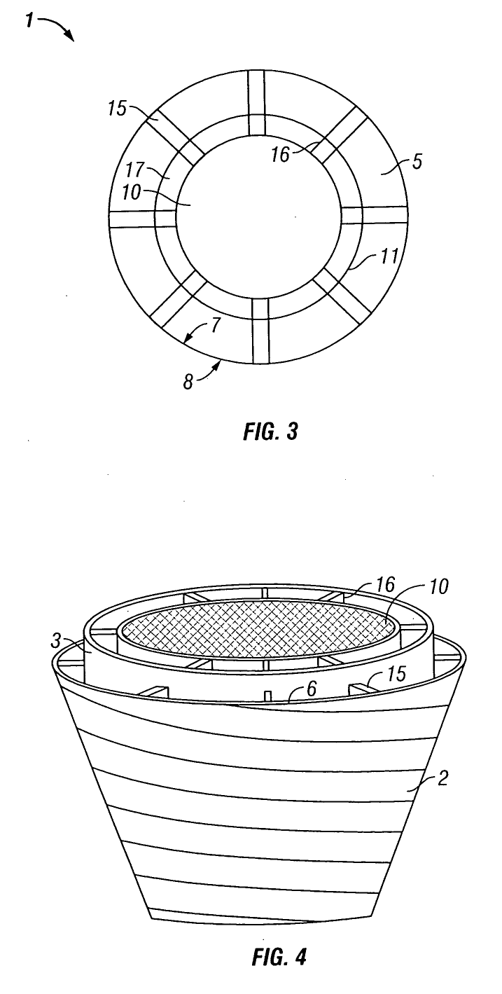

As shown more clearly in FIGS. 2 and 3, a plurality of support frames (15) are disposed within the trough (5) in spaced-apart fashion which brace the sidewall (11) of the ice cream engaging platform (3) against the inner surface (7) of the cone (2).

The ice cream engaging platform (3) is also mounted to the hand engaging surface (2) such that its upper surface (10) is in an elevated position relative to the trough (5) when in use.

The ice cream engaging platform (3) also includes a hollow buffer (17) behind the sidewall (11). Typically a plurality of support frames (16) are disposed within the hollow buffer (17) which brace the sidewall of the ice cream engaging platform.

FIG. 4 depicts a further embodiment of the present invention wherein the tapered end of the ice cream cone (3) includes a flat-bottom to allow the cone to be rested on a flat surface if required.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

What is claimed is:

1. An ice cream holder including:
a hand-engaging surface; and
an ice cream engaging platform mounted to the hand engaging surface; and
a collector disposed between the hand-engaging surface and the ice cream engaging platform adapted for collecting ice-cream that is spilt from the ice-cream engaging surface when in use.

2. An ice cream holder as claimed in claim 1 including an edible material.

3. An ice cream holder as claimed in any one of claims 1 or 2 including a cone, wherein a tapered end of the cone provides the hand-engaging surface.

4. An ice-cream holder as claimed in claim 3 wherein the ice cream engaging platform includes:
an upper surface upon which ice cream may be deposited in use; and
a sidewall surrounding the upper surface; and
a base.

5. An ice cream holder as claimed in claim 4 wherein the upper surface includes at least one of:
a substantially flat surface; or
a recessed surface.

6. An ice cream holder as claimed in claim 5 wherein the collector includes at least any one of the following:
a trough; or
a guard disposed between, and extending outwardly from, the ice cream engaging platform and the hand engaging surface.

7. An ice cream holder as claimed in claim 6 wherein the guard includes a lip disposed adjacent the rim of the ice cream cone which is adapted to curve over the user's hand in use.

8. An ice cream holder as claimed in claim 7 wherein the base of the ice cream engaging platform is connected to the inner surface of the cone whereby a trough is formed between the sidewall of the ice cream engaging platform and the inner surface of the cone.

9. An ice cream holder as claimed in claim 8 including a plurality of apertures disposed along a bottom surface of the trough, the plurality of apertures being adapted to provide drainage for ice cream that has accumulated within the trough into a hollow tapered section of the cone.

10. An ice cream holder as claimed in claim 9 wherein the ice cream engaging platform is mounted to the hand engaging surface such that it is arranged in an elevated position relative to the collector.

11. An ice cream holder as claimed in claim 10 including a plurality of support frames disposed within the trough in spaced-apart fashion which are adapted to brace the sidewall of the ice cream engaging platform against the inner surface of the cone.
